(19) United States
(12) Patent Application Publication
(10) Pub. No.: US 2010/0220986 A1
(43) Pub. Date: Sep. 2, 2010

(54) Image-Taking Apparatus and Control Unit for Focus Control

(75) Inventors: Rolf Eigenheer, Rheinau (CH); Romano Padeste, Schaffhausen (CH)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: SINAR AG, Feuerthalen (CH)

(21) Appl. No.: 12/225,409

(22) PCT Filed: Mar. 22, 2006
(86) PCT No.: PCT/CH2006/000169

§ 371 Date: Jan. 23, 2009

(51) Int. Cl. G03B 13/32

(52) U.S. Cl. 396/89

(57) ABSTRACT

The method of manufacturing a photograph comprises, in the following order, the steps: a) focussing, so as to reach a first focussing state (A), which is a desired in-focus state with respect to an image plane (87) of a focussed-state detection arrangement (70); b) shifting from said first focussing state (A) to a second focussing state (B), which is different from said first focussing state (A); and c) taking an image by means of said image taking element (60). The image taking apparatus (1) comprises an image-forming optical system (20); a focussing section (29); a focussed-state detection arrangement (70); an image taking element (60); and a control module (4); wherein said control module (4) is adapted to adjusting said focussing section (29), so as to shift from said first focussing state (A) to said second focussing state (B). An enhanced control of the in-focus state of taken images can be achieved. In one aspect, very sharp focussing can be achieved, and in another aspect, the formation of Moiré patterns may be effectively suppressed.

### TECHNICAL FIELD

The invention relates to the field of photography, and in particular to an image taking apparatus and a control unit for an image taking apparatus and to a method of manufacturing a photograph.

### BACKGROUND OF THE INVENTION

The invention originated from the demand for high accuracy focussing in photography. Photo camera bodies, in particular single lens reflex cameras, with detachable film cartridges and/or detachable digital backs are known in the art. In order to allow for taking properly focussed photographs with such a camera, an image viewed in a groundglass or other optical means of a view finder has to represent the image captured in the film cartridge or in the digital back as precisely as possible. Foil stacks can be arranged between the lens system and the digital back or film cartridge for compensating path length differences, which can be due to manufacturing tolerances, wear due to intensive use of the camera system or—last but not least—due to the photographers way of working or his improperly focused eyes, and which would lead to a slightly out-of-focus position in the photograph, although the image in the view finder was—at least apparently—in-focus. Such a foil stack consists of a large number of joined thin foils (about 50 μm thick each) and can be attached between the camera body and the film cartridge or digital back. By peeling off foils one-by-one from the stack and comparing captured images and the images in the view finder, an optimized agreement between the images can be achieved for one single given combination of camera body and digital back. If too many foils have been removed from the foil stack, a new foil stack of sufficient thickness has to be employed, and the above-described adjusting procedure has to be started again. The thickness of the foil stack cannot be increased, but only decreased.

As another solution for this problem, manufacturers have offered adapter plates of various thicknesses, which are to be placed between the camera body and the digital back. This solution is even less flexible than the one with the foil stacks.

It is desirable to provide for an alternative way of manufacturing precisely focussed images.

More general, it is desirable to provide for an increased flexibility in adjusting a desired in-focus state with respect to an image plane of an image taking element of an image taking apparatus.

### SUMMARY OF THE INVENTION

A goal of the invention is to create a method of manufacturing a photograph and an image taking apparatus that provide for additional degrees of freedom with respect to the adjustment of a desired in-focus state with respect to an image plane of an image taking element of the image taking apparatus.

An object of the invention is to provide for an increased flexibility in focussing.

Another object of the invention is to provide for a method of manufacturing a photograph and an image taking apparatus and a control unit for an image taking apparatus, which allow to manufacture photographs in a way that the relation between an in-focus state of the manufactured images and an in-focus state of images examined (e.g., viewed or detected) for focussing before taking the image can be accurately and reproducibly adjusted. Note that an in-focus state is characterized by what in an imaged scene is in focus, i.e., where in the image scene is—maximum-sharpness.

Another object of the invention is to provide for a method of manufacturing a photograph and an image taking apparatus and a control unit for an image taking apparatus, which allow to manufacture photographs in a way that the relation between an in-focus state of the manufactured images and an in-focus state of images viewed for focussing before taking the image can be adapted to individual needs and preferences (of the photographer).

Another object of the invention is to provide for a method of manufacturing a photograph and an image taking apparatus, which allow for an enhanced control of the in-focus state of taken images.

Another object of the invention is to provide a photographer with greater and more precise control of the focussing state of taken photographs.

Another object of the invention is to provide for an enhanced focussing control.

These objects are achieved by an image taking apparatus, by a control module for an image taking apparatus and by a method of manufacturing a photograph according to the patent claims.

The control module for an image taking apparatus is adapted to adjusting a focussing section of said image taking apparatus, so as to shift from a first focussing state to a second focussing state, wherein
said first focussing state is a desired in-focus state with respect to an image plane of a focussed-state detection arrangement of said image taking apparatus, and wherein
said second focussing state is different from said first focussing state.

The image taking apparatus comprises
an image-forming optical system;
a focussing section;
a focussed-state detection arrangement with an image plane;
an image taking element for taking an image in an image plane of the image taking element;
a control module;
   wherein said control module is adapted to adjusting said focussing section, so as to shift from a first focussing state to a second focussing state, wherein
said first focussing state is an in-focus state with respect to said image plane of said focussed-state detection arrangement, and wherein
said second focussing state is different from said first focussing state.

The method of manufacturing a photograph comprises, in the following order, the steps of:

a) focussing, so as to reach a first focussing state, which is a desired in-focus state with respect to an image plane of a focussed-state detection arrangement;
b) shifting from said first focussing state to a second focussing state, which is different from said first focussing state; and
c) taking an image by means of said image taking element.

Through this, an enhanced control of the in-focus state of taken images can be achieved.

The invention may be used for achieving various effects and creating several degrees of freedom. Two possible aspects will be discussed in details below.

1. On a first aspect (or application) of the invention: high-precision focussing:
An object of the invention is to create a method of manufacturing a photograph and an image taking apparatus that does not have the disadvantages mentioned above.
Another object of the invention is to allow for high-precision focussing.
Another object of the invention is to allow for a comfortable way of focussing with a high precision.
Another object of the invention is to allow for a way of correcting for manufacturing and/or assembling tolerances that would lead to not-properly-focussed photographs, and in particular to provide for a comfortable way of doing so.
Another object of the invention is to provide for a method of manufacturing a photograph and an image taking apparatus and a control unit for an image taking apparatus, which allow for manufacturing photographs with a precisely predictable in-focus state even with a modular image taking apparatus, e.g., with an apparatus having a detachable image taking element (like a digital back and/or a detachable view finder).

These objects are achieved when said second focussing state is closer to the desired in-focus state with respect to said image plane of said image taking element than said first focussing state, in particular, when said second focussing state is the desired in-focus state with respect to said image plane (86) of said image taking element.

2. On a second aspect (or application) of the invention: suppression of Moiré patterns:
An object of the invention is to provide for a way of avoiding imaging artifacts in image-taking of objects with periodic patterns.
Another object of the invention is to provide for an elegant way of avoiding or suppressing the formation of Moiré patterns in taken images.
Another object of the invention is to provide for additional degrees of freedom or parameters in image-taking of objects with periodic patterns.
Another object of the invention is to allow for the suppression of the formation of Moiré patterns in taken images in a well-defined and predictable way.

These objects are achieved when said second focussing state is a focussing state chosen such that said image taken in said image plane of said image taking element is deliberately slightly out-of-focus.

Said second focussing state can be a fixed focussing state different from the desired in-focus state with respect to said image plane of said image taking element.

Or, said second focussing state can be a transient focussing state close to or comprising the desired in-focus state with respect to said image plane of said image taking element. “Transient focussing state” means that the focus is not constant, but varies; in other words: there is a deliberate focus-shift while the image is taken.

The method of manufacturing a photograph may also be understood as a method of operating an image taking apparatus, or as a method for taking a photograph, or as a method of focussing with an image taking apparatus, or, in the first aspect of the invention, as a method for compensating manufacturing and/or assembling tolerances in an image taking apparatus.

Taking an image may be considered capturing an image or recording an image. Photographic images are usually considered here, regardless whether taken chemically (typically on roll film, sheet film or photographic plate) or electronically (typically using a charge-coupled device “CCD” or a light-sensitive CMOS sensor, which both may be of a linear array or an area type). In its second aspect, the invention has particular importance in conjunction with electronic picture taking, because therein periodically arranged photosensitive members (e.g., a matrix-like array of semiconductor pixels, photodiodes) are most frequently used.

Usually, still images are considered to be taken, but moved images may be considered, too.

Said first focussing state can be considered a before-image-taking focussing state. This focussing state is reached at the end of a focussing procedure, which can be an ordinary state-of-the-art focussing procedure, be it autofocussing, or be it manual focussing (by moving the focussing ring of a lens arrangement, or by moving the image taking apparatus, or the like).

Said second focussing state can be considered a during-image-taking focussing state. This focussing state is reached from said first focussing state. The focus shift can, in the first aspect of the invention, compensate for unavoidable, usually tiny tolerances (for medium-format systems usually well below 1 mm, typically of the order of 100 μm to 200 μm and below; for large-format systems maybe several hundred micrometers; and for very small systems maybe as little as only some micrometers). Or, in the second aspect of the invention, may avoid the formation of Moiré patterns in the taken image.

In other words, firstly, a (first) focussing state is selected in accordance with a focussed-state detection arrangement. I.e., the (maximum) sharpness, as detected by means of the focussed-state detection arrangement, is in a desired place, or in other words, a desired in-focus state with respect to the image plane of the focussed-state detection arrangement is reached. And then, another (second) focussing state is selected (through shifting from said first focussing state).

In the first aspect of the invention, in the second focussing state, an image can be taken with the (maximum) sharpness in the same place (in the image) as (before) with respect to the focussed-state detection arrangement. This can be considered a corrective focussing, a corrective adjusting, a focus fine adjustment or a corrective shift of focus. A simple practical example for illustrative purposes:

In portrait photography, the photographer wants that the zone of sharpness ranges from the front of the eyelashes to the iris. Accordingly, the photographer focuses such (and selects the appropriate aperture), that he perceives an according image in the camera's view finder. The first focussing position is reached, since a desired in-focus position with respect to the image plane of the focussed-state detection arrangement (groundglass of view finder) has been established. Without changing the focussing position, the image recorded by means of the camera's digital back would show sharpness possibly somewhere near the tip of the nose (exaggerated example), which is not the desired in-focus state. Therefore, before taking an image, the camera shifts to the second focussing position, in which the desired in-focus position is reached with respect to the image plane of the CCD or CMOS chip of the digital back. In that second focussing position, which is slightly defocussed with respect to the first focussing position, the zone of sharpness as captured in the CCD or CMOS chip ideally ranges from the front of the eyelashes to the iris, as desired, or, at least, the zone of sharpness in the CCD- or CMOS-captured image is closer to what the photographer desired. If not only the place of maximum sharpness shall be in the same place, but also the full zone of sharpness shall be in the same region, apertures have to be chosen accordingly in the first and in the second focus state.

In the first aspect of the invention, said second focussing state preferably is (as exactly as possible) said desired in-focus position with respect to the image plane of the image taking element. Said second focussing state shall be considered to be said desired in-focus position with respect to the image plane of the image taking element, when the second focussing state is as close to said desired in-focus position with respect to the image plane of the image taking element as it is possible (by means of the corresponding image taking apparatus), or, in other words, when the respective positions agree within tolerances of said shifting from first to second focussing positions. The closeness to the “ideal” focussing state might be limited, e.g., by a minimal step width with which focussing states can be shifted (e.g., a couple of micrometers or a couple of 10 μm per step) and/or unavoidable play (backlash).

In the second aspect of the invention, the second focussing state is not identical with the first focussing state, but provides for a slightly out-of-focus position. The minimal blur created this way, be it by a fixed or by a transient focussing state, eliminates Moiré patterns in the taken image.

Typically, said first focussing state corresponds to a first state (or position) of said focussing section. Said second focussing state may correspond to a second state (or position) of said focussing section and may, in the second aspect of the invention, correspond to a movement of said focussing section.

Said focussing section can comprise a part of said image-forming optical system.

Said image-forming optical system usually comprises a number of lenses and an aperture.

It is possible to change into said second focussing state just after a camera's release button has been pushed (or the camera system has been released by other means) and to return to said first focussing state just after the image has been taken.

In one embodiment, the change from said first to said second focussing state is accomplished automatically.

In one embodiment, the change from said second focussing state back to said first focussing state is accomplished automatically.

If, in the second aspect of the invention, the second focussing state is a transient focussing state, the corresponding change in focus may be accomplished automatically.

The image taking apparatus may be considered to work in at least two modes: a focussing mode, at the end of which the first focussing state is reached, and an image taking mode, during which the image is taken while in the second focussing state.

In one embodiment, a drive, in particular a motor, is used to achieve said change (shift) from said first to said second focussing state, and possibly also the change in focus corresponding in a transient focussing state. That drive can, e.g., be a drive as used for focussing in autofocus cameras, and in particular, it may be the very same drive as in an autofocus camera.

In one embodiment, both, a light path forming an image in said image plane of said image taking element, and a light path forming an image in said image plane of said focussed-state detection arrangement, pass through said image-forming optical system.

In one embodiment, said light paths are at least partially identical with each other.

In one embodiment, said light paths have nearly the same optical path lengths, differing by an optical length δ0. This optical length δ is usually well below 1 mm, typically of the order of 100 μm to 200 μm and below. It may, however, vary over time (e.g., due to wear) or due to combining different modules.

By means of said focussed-state detection arrangement, it can be decided whether or not a desired in-focus state with respect to the image plane of the focussed-state detection arrangement is reached. This decision may be made by the focussed-state detection arrangement itself, e.g., in case of an autofocus sensor as focussed-state detection arrangement. Or, the decision may be made by the photographer, by eye, i.e., looking at the image formed in the image plane of the focussed-state detection arrangement, the photographer decides whether the desired in-focus state is reached or not. If not, the photographer will usually focus differently (i.e., change the focus state), until the desired in-focus state is reached, i.e., until the (zone of) sharpness is where the photographer wants it to be.

In one embodiment, said focussed-state detection arrangement comprises at least one of
an autofocus sensor;
a focussing screen;
an imaging photoelectric converter, in particular a CCD chip, a CMOS chip or another arrangement of photosensitive members (e.g., an arrangement of photodiodes).

The focussed-state detection arrangement may be part of a view finder, in particular of a waist level view finder or prism view finder.

Said image taking element may be considered an image capture element or an imaging photosensitive element.

In one embodiment, said image taking element comprises an imaging photochemical converter, in particular photographic film.

In one embodiment, said image taking element comprises an imaging photoelectric converter, in particular a CMOS chip or a CCD chip.

Any of the mentioned focussed-state detection arrangements may be combined with any of the mentioned image taking elements.

In one embodiment, said changing (shifting) from said first to said second focussing state (corresponding to step b of the method of manufacturing a photograph) is a shifting of the focus by a predetermined amount. That predetermined amount will usually be the above-mentioned δ.

A proper value for the predetermined amount (typically δ) may be found manually, or even automatically as will be described below.

In one embodiment, said image taking apparatus is a still image registering (recording) apparatus.

The invention may, in other words, possibly also be described as follows: An image of a scene is to be captured. It is focussed such, that the scene, as observed by means of a focus-position-checking means (focussed-state detection arrangement), appears in a desired way (as far as focus/place of—maximum-sharpness is concerned). Then, before capturing the image, it is slightly defocussed.

In the first aspect of the invention, is it slightly defocussed in such a way that the scene as captured in the image appears in the desired way (or at least: appears more similar to the desired way than it would without the defocussing). Or, shorter and maybe less precise: After an ordinary focussing and before taking the image, the focus is slightly changed for compensating tolerances, in particular undesired path length differences between the light path when checking the focus and the light path when capturing the image.

In the second aspect of the invention, it is slightly defocussed in such a way, that a desired tiny (constant or varying) path length difference (with respect to the second focussing state according to the first aspect of the invention) is introduced.

In the second aspect, the invention may address the problem of the formation of Moiré patterns on image sensors (image taking elements), which is a problem that may arise when periodic (regular) patterns are imaged by means of a regular arrangement of photosensitive members, e.g., when woven fabrics are imaged using a CCD or CMOS chip.

The advantages of the methods correspond to the advantages of corresponding apparatuses and vice versa.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a block diagram of a method of manufacturing a photograph;

FIG. 2 an image taking apparatus in a first focussing state (A, upper part) and in a second focussing state (B, lower part), schematically;

FIG. 3 an image taking apparatus, schematically

FIG. 4 an illustration of a second aspect of the invention with fixed second focussing state;

FIG. 5 an illustration of a second aspect of the invention with transient second focussing state.

The reference symbols used in the figures and their meaning are summarized in the list of reference symbols. Generally, alike or alike-functioning parts are given the same or similar reference symbols. The described embodiments are meant as examples and shall not confine the invention.

### DETAILED DESCRIPTION OF THE INVENTION

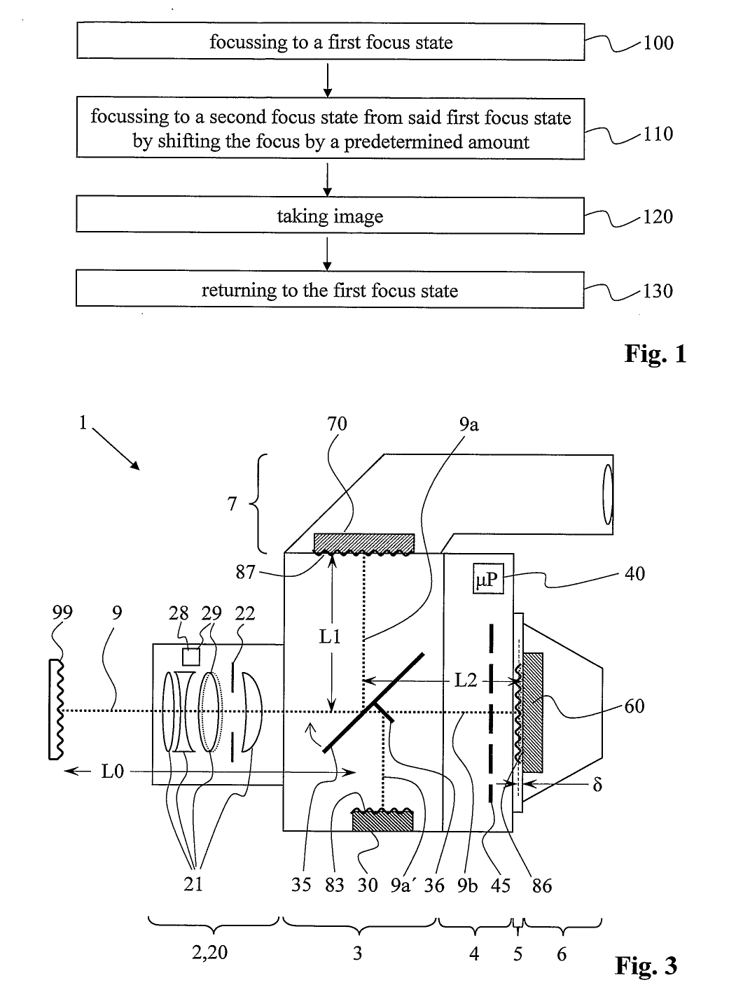

FIG. 1 shows a block diagram of a method of manufacturing a photograph. In step 100, a first focussing state is reached, which may be achieved automatically using an autofocus system or manually, typically be turning a focussing ring of a lens barrel. Then, in step 110, from said first focussing state a second focussing state is reached. This may be achieved by shifting the focus by a predetermined amount, typically by using a motor control.

In step 120 then, while maintaining said second (fixed or transient) focussing state, an image is taken, be it digitally (using a CCD chip or the like) or “analogue”, i.e. using chemical film material.

Finally, in optional step 130, said first focussing state is reached again (i.e., returning to first focussing state).

This way, before and after capturing the image, the first focussing state is set, and a user of the image taking apparatus can look at the image in a view finder (if provided), thus having a reference according to which he decides that a desired in-focus state is set. Nevertheless, during taking the image, corrective action has been taken, so as to reach said second focussing state, which will ensure, in a first possible aspect of the invention (maximized sharpness), that the taken image exactly reflects said desired in-focus state (sharpness in exactly the same place), despite of tolerances from manufacturing or assembling the image taking apparatus, or, in a second possible aspect of the invention (Moiré-suppression), avoid the formation of Moiré patterns in the taken image by being (fixedly) slightly off-focus with respect to said second focussing state or by slightly changing the focus during image-taking (transient second focussing state).

For more details on the first and second aspects of the invention, it is referred to above, to the chapter summarizing the invention.

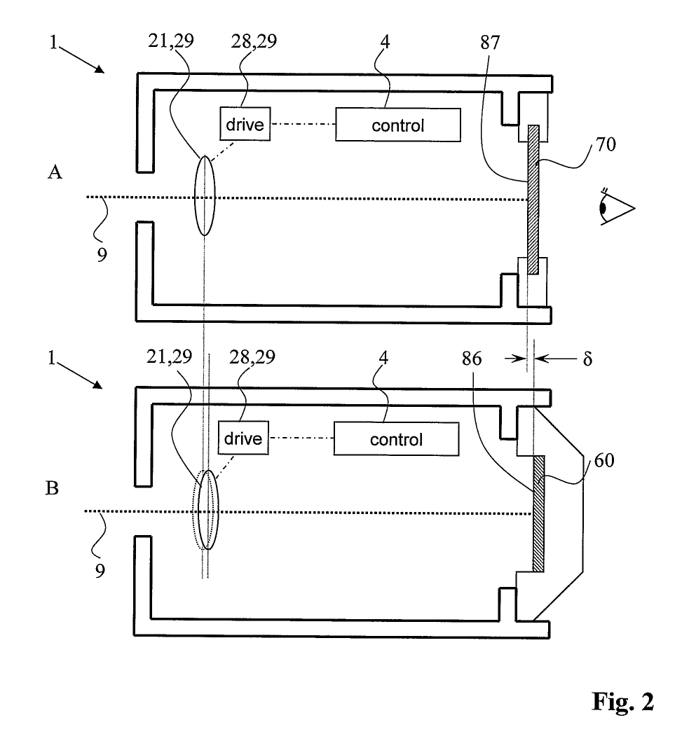

FIG. 2 shows schematically a simple image taking apparatus 1 in said first focussing state (A, upper part of FIG. 1) and in said second focussing state (B, lower part of FIG. 1). In the following, FIG. 2 will be discussed with emphasis on the first aspect of the invention.

The image taking apparatus 1 is drawn very schematically and may represent a view camera (bellows not indicated as such in FIG. 1). The dotted line labelled 9 represents a light path (or a light beam, or the optical axis of the camera).

The image taking apparatus 1 comprises a focussing section 29, realized as a lens 21 and a drive 28, a control module 4 and a focussed-state detection arrangement 70, which is realized as a groundglass 70. The focussed-state detection arrangement 70 has an image plane 87. By means of the focussed-state detection arrangement 70, it is decided whether or not a desired in-focus state is reached, i.e., whether or not the sharpness is in the desired place (location).

The drive 28 is controlled by the control module 4 and can move the lens 21, so as to change the focus. The according functional connections are drawn as dash-dotted lines. Manually or via said drive 28, a photographer may choose the position of the lens 21 such that he can see an image on the groundglass 70 in a desired in-focus state. On the right of the image taking apparatus, an eye of the photographer is sketched.

After this first focussing state A is reached, the groundglass 70 may be replaced by an image taking element 60, e.g., a CMOS chip or CCD chip 60 (or a photochemical film). The image plane 86 of the image taking element 60 is not precisely at the very same position as the groundglass 70 was before. The optical path length of a light path forming an image in said image plane of said image taking element is larger by a value δ than the optical path length of a light path forming an image in the image plane of said groundglass 70.

Without further corrections, the image taken in that focussing state would not perfectly correspond to the image viewed on the groundglass. It would be slightly defocussed.

Therefore, the focussing section 29 will focus to the second focussing state B shown in the lower part of FIG. 2. Controlled by the control module 4, the drive 28 will move lens 21 such that the image is in-focus in the image plane of the image taking element 60. Accordingly, the (maximum) sharpness will be in precisely the same place as it has been on the groundglass 70.

If apertures are set in the same way in the first focussing state and in the second focussing state, maximum sharpness will not only be in the same place (location) in both states, but also the width (and position) of the zone of sharpness will be the same in both states.

For a given image taking apparatus 1, the optimum value for the focus shift (typically corresponding to δ) or for the amount the drive 28 has to move the lens 21 can, e.g., be found by focussing to the first focussing state A (control via the focussed-state detection arrangement 70) and then repeatedly taking images by means of the image taking element 60, each taken at a slightly different focussing state (chosen via the control module 4), and then deciding, at which of the various focussing states the taken image corresponds best to the image viewed in the focussed-state detection arrangement 70, i.e., where the desired in-focus state is reproduced best. The corresponding focus shift is the desired optimum value for the image taking apparatus 1 (with the image taking element 60 and focussed-state detection arrangement 70). When, instead of the image taking element 60, a different image taking element, e.g., a film cartridge, shall be used, similar calibration measurements can be made in order to find the appropriate optimum focus shift for that different image taking element 60. The focus shift may as well be expressed in terms of a correction value to be used by the control circuit for correctively adjusting the focussing section.

It is also possible to determine an appropriate optimum focus shift (or correction value) automatically, e.g., if a first CCD or CMOS chip is used as focussed-state detection arrangement and a second CCD or CMOS chip as image taking element. In that case, images taken with the first CCD or CMOS chip and images taken with the second CCD or CMOS chip can be compared digitally, e.g., using a computer (internal or external to the image taking apparatus), and even the image taking at a slightly different focussing states may be automated.

It is possible to foresee to store appropriate individual correction values that are characteristic for one individual module (e.g., a specific view finder or a specific digital back or a specific film cartridge) in the individual module. Such individual correction values may even be determined by the manufacturer. It is possible to foresee that an image taking apparatus receives (electronically, digitally) from attached modules the respective individual correction values and calculates therefrom the optimum (system) correction value for taking images in that specific system configuration, i.e., with the currently attached modules. I.e., individual modules comprise information about their individual tolerances, and this forms a basis for determining δ and/or an appropriate system correction value. In addition, it is possible to provide for such correction values, which are dependent on the photographing individual (photographer A vs. photographer B) and/or an different photographic applications (e.g., portrait photography vs. landscape photography vs. architecture photography and so on).

It is known that the perception of “sharpness” by the human eye is somewhat subjective, i.e., it depends, to a small degree, on the perceiving individual (photographer). Note that a range, during which an image is perceived as sharp (i.e., correctly in-focus) by different persons may, in case of a medium-format system, correspond to a focus-shift of about 50 μm to 100 μm (in large-format systems, it may correspond to several hundred micrometers, and in very small systems, e.g., with small imaging chips, it may correspond to some micrometers).

It is possible to choose the focus shift in such a way that the individual (personal) preferences of the photographer with respect to his perception of “sharpness” are precisely reflected.

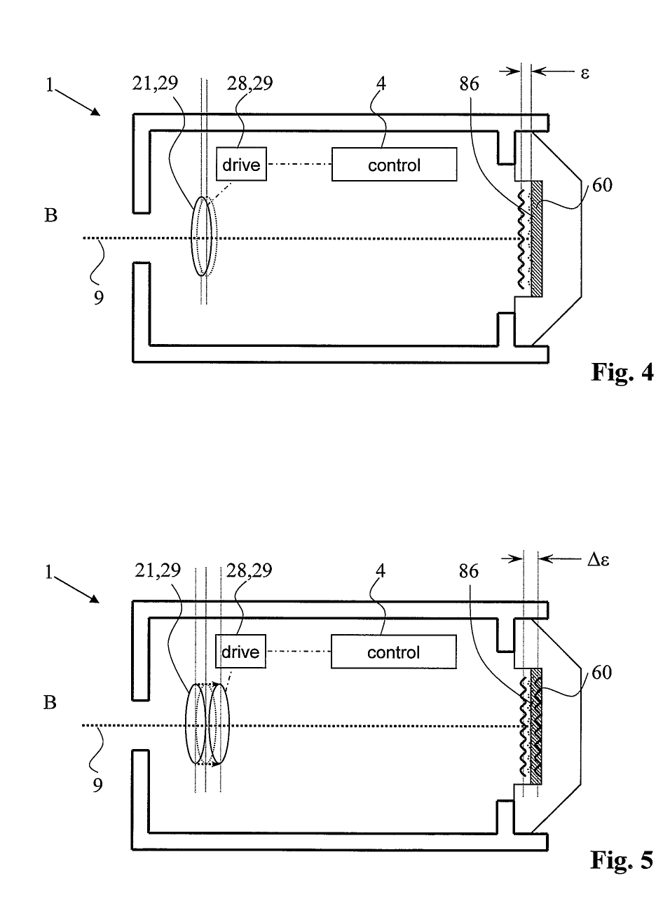

When interpreting FIG. 2 with respect to the second aspect of the invention, there might be (as drawn) a δ≠0, i.e., when the desired in-focus-state is perceivable from the focussed-state detection element 70, it will not be the same as in the image plane of the image taking element 60. But δ could as well be zero, i.e., perfect match of in-focus states with respect to focus-state detection arrangement 70 and to image taking element 60. The shifting from the first focussing state A to the second focussing state B according to the second aspect of the invention is illustrated in FIG. 4.

FIG. 4, which can be interpreted as corresponding to the lower part of FIG. 2, illustrates the second aspect of the invention in the case of a fixed second focussing position B. Furthermore, it shall for the moment be assumed that already in the first focussing state the desired in-focus state with respect to the image taking element 60 is reached (δ=0). This is illustrated by the dotted wavy line at the image taking element 60 and the corresponding dotted position of the lens 21 of the focussing section 29. In order to avoid that this “perfect” sharpness results in an undesired Moiré pattern when imaging a periodically patterned object, a different, slightly out-of-focus state is selected by means of the drive 28 changing the position of lens 21 (drawn in solid lines). The corresponding image is sketched as the solid wavy line in FIG. 4. The somewhat out-of-focus position manifests itself in a focus shift ε≠0. In the case of a medium format system, ε may have values typically of the order of 5 μm to 40 μm.

I.e., a deliberate slight defocussing is introduced, with respect to the “perfect” sharpness state (corresponding to the second focussing state according to the first aspect of the invention). If, in the first focussing state, the desired in-focus state with respect to the image plane of the image taking element 60 is not reached (δ≠0), which is normally the case (i.e., in the first focussing state it is not yet provided for “perfect” sharpness at the image taking element 60), it is advantageous to choose the amount of defocussing (ε≠0) for the second focussing state (for “anti-Moiré”) with respect to the “perfect” sharpness state (i.e., with respect to the second focussing state according to the first aspect of the invention). The image is taken while in the second focussing state. It is possible and desirable to provide a parameter for this “anti-Moiré”-defocussing, which is related to ε so that the photographer may select, how strong the defocussing shall be.

In analogy to FIG. 4, FIG. 5 illustrates the second aspect of the invention in the case of a transient second focussing position B. The focus is deliberately shifted while taking the image. This is accomplished by the drive 28 shifting the lens 21 from an initial to a final position, depicted in FIG. 5 by the lens 21 drawn two times in solid lines and by the dashed arrows therebetween. Accordingly, the resulting images are moved while in the vicinity the image plane of the image taking element 60. The corresponding initial and final positions are illustrated as two solid wavy lines. The path, which the desired in-focus state travels, is depicted by the focus shift Δε in FIG. 5. The transient second focussing state is a very effective way of avoiding Moiré patterns, even when the periodic pattern of the object to be imaged extends not only transversally, but is inclined laterally (with respect to the light path).

Various focus shifts Δε may be chosen. The length of Δε may be varied: the larger, the more Moiré suppression, but the smaller, the sharper the image. In particular, the length of Δε may be chosen in dependence of the aperture with which the image shall be taken. The initial and the final focus state of the Δε interval may be varied, e.g., the “perfect” sharpness position may be within the Δε interval (like shown in FIG. 5), or the “perfect” sharpness position is identical with the initial or the final focus state of the Δε interval, or the “perfect” sharpness position is outside of the Δε interval. The velocity (speed, even possibly time-dependent) of the focus shift of the transient second focussing state may be varied, in particular in dependence of the exposure time for the image to be taken. It is possible and desirable to provide at least one parameter for this “anti-Moiré”-defocussing with transient second focussing state, so that the photographer may select, how the defocussing shall be accomplished, and how strong the defocussing shall be. There may also be provided for a user-selectable parameter for selecting “anti-Moiré” with fixed or with transient second focussing state. In the case of a medium format system, Δε may typically have values of the order of 5 μm to 50 μm.

FIG. 3 shows schematically an image taking apparatus 1. This exemplary apparatus 1 is a modular single-lens reflex camera 1. It has the following parts, which are all (optionally) detachable: a lens module 2, a focussed-state detection module 3, a control module 4, an optional adapter plate 5, an image taking module 6 and a focussed-state detection module 7.

The lens module 2 (or lens barrel 2 or objective module 2) corresponds to an image-forming optical system 20 comprising a number of lenses 21 and an aperture 22 and possibly a shutter (not shown). A part of the lenses 21 (optionally all lenses) forms a part of a focussing section 29, which also comprises a drive 28 (for focussing). The drive 28 does not have to be arranged at or within the lens barrel 2.

The lens barrel 2 is attached to the focussed-state detection module 3, which in the camera of FIG. 1 is at the same time a mirror module containing a mirror arrangement comprising a main mirror 35 and an auxiliary mirror 36. The mirror arrangement may also be considered a light redirecting element or a beam splitter. Light from an object 99 to be imaged runs along a light path 9 through the image-forming optical system 20 and hits, after an optical path length L0, the main mirror 35. The upwardly reflected light follows a light path 9a of length L1 to a groundglass focussing screen 70 as focussed-state detection arrangement 70 of a focussed-state detection module 7, which is embodied as a view finder module 7 attached to the mirror module 3. The focussed-state detection module 7 may, in general, present images for example optically or electro-optically. The thick wavy line represents the image of the object 99 in the image plane 87 of focussing screen 70.

As a second focussed-state detection arrangement 30, the camera 1 comprises an autofocus sensor 30. Light from the object 99 reaches the autofocus sensor 30 on a light path 9a′ through the main mirror 35 and via reflection at the auxiliary mirror 36. Thus, an image is formed in an image plane 83 of the autofocus sensor 30. Usually, the optical path length from object 99 to the image plane 83 of the autofocus sensor 30 is the same as the optical path length from object 99 to the image plane 87 of the focussing screen 70, which amounts to L0+L1. It may, however be different, e.g., larger by a fixed amount, or proportionally related thereto, or having another well-defined relation thereto.

Accordingly, in the image taking apparatus of FIG. 1, there are two alternatively usable ways to ensure that a desired (first) focussing state is reached: by means of the autofocus sensor 30 and by means of the groundglass focussing screen 70.

When a photograph shall be taken, the mirror arrangement (main mirror 35 and auxiliary mirror 36) is moved as indicated by the small arrow. This lets the light pass along a light path 9b through the control module 4, which contains a shutter 45, and a control circuit 40 embodied in a microprocessor μP. The shutter 45 and a control circuit 40 do not necessarily have to be arranged within the control module 4. The control circuit 40 may control the drive 28, the aperture 22, a mechanism for moving the mirror arrangement (not shown) and the shutter 45 and other functions of the image taking apparatus. It may receive input from the autofocus sensor 30, from light intensity sensors (not shown) and from other sources (including the photographer). For reasons of clarity, the functional connections of the control circuit 40 to the various units and elements are not shown in FIG. 3.

After passing the control module 4, the light will pass the adapter plate 5 and impinge on an image taking element 60 of the image taking module 6, which is embodied as a digital back 6 with a CCD or CMOS chip 60. Between the object 99 and the main mirror 35, the light path is identical for light producing an image in the groundglass 70, for light captured in the autofocus sensor 30, and for light producing an image on the CCD or CMOS chip 60.

In the following, FIG. 3 will be explained mainly under the first aspect of the invention (absolute sharpness):

The optical path length from the object 99 to the image plane 86 of the image taking element 60 is L0+L2, which is approximately equal to L0+L1, but is longer by a small path length difference δ=L2−L1, and it may as well be smaller (in which case δ would be negative). Accordingly, the image (with the sharpness in the desired location) does not exist in the image plane 86, but slightly before the image plane 86 (indicated by the solid wavy line), and in the effectively taken image has the sharpness is in a slightly different place. As sketched above, it is possible that, even in the ideal case (no tolerances, perfect adjustment), L0+L1 and L0+L2 are different from each other and related to each other by some well-defined function. In that case, one may still define the path length difference δ, which depicts the deviation from the ideal state.

The small path length difference δ is due to unavoidable manufacturing and/or assembling tolerances, typically of the order of several 10 μm (for medium-format systems). But the invention could be used even for image taking apparatuses 1 with higher path length differences, maybe up to 1 mm or even more, e.g., in the case of larger format systems. Note that the minimum depth of field (aperture fully opened) in a medium format system typically extends over approximately 100 μm.

In order to remedy this problem, the control module 4 (more precisely, the control circuit 40) will instruct the drive 28 to slightly defocus (shift the focus) so as to reach a second focus position (indicated by the dotted lens 21), such that in the image plane 86 the (maximum) sharpness is in the desired place (indicated as the dotted wavy line at the image taking element 60). This focus shift may take place while the mirror arrangement is moved (turned). Then the shutter 45 is opened, and an image is taken (captured) in this second focussing state. When the image is captured and the shutter 45 is closed, the first focussing state can be reestablished, so that the photographer looking at the groundglass 70 sees the image with the sharpness in the desired place.

If the aperture 22 is set to the same opening during both focus states A,B, the zone of sharpness is in exactly the same region in the two states A,B (position and width).

The focussing section 29 is preferably as backlash-free as possible (no or very little play) and allows for fast focussing action. This may allow to implement a very precise focus shift without increasing the time needed from pressing the release button to taking (recording) the image. The focus shift may take place while the mirror arrangement is moved.

From the explications above and from the illustrations (FIGS. 3, 4 and 5), it will be clear, how the embodiment of FIG. 3 can be interpreted and used in the sense of the second aspect of the invention (“anti-Moiré”).

As described above, it is possible to use the (anyway existing) focussing section 29 of the image-forming optical system 20 for shifting the focus in the above-described way. An advantage of this is, that no additional devices have to be provided for in the image taking apparatus 1 (if a drive 28 is already provided for) in order to accomplish for the focus shift.

Nevertheless, it is possible to achieve a correction for manufacturing and/or assembling tolerances as well as a suppression of Moiré patterns also by other means. E.g., the image taking element 60 could be moved, e.g., mechanically or piezoelectrically, so as to allow for taking images with the zone of sharpness in the desired region (as detected by one of the focussed-state detection arrangements 30, 70) or for taking images with a deliberate slight defocussing against Moiré patterns. Or, one or both focussed-state detection arrangements 30, 70 could be moved accordingly, e.g., mechanically or piezoelectrically, for adjusting the path length with respect to the image taking element. This way, a δ=0 is achieved and no change of focussing state is necessary, since the zone of sharpness is always in the same region in the image plane 86 image taking element 60 and in the image plane of (at least one of) the focussed-state detection arrangements 30, 70.

List of Reference Symbols

| | |
|---|---|
| 1 | image taking apparatus, camera system, camera, |
| | photographic camera |
| 2 | lens module, objective module, lens barrel |
| 20 | image-forming optical system |
| 21 | lenses |
| 22 | aperture |
| 28 | drive |
| 29 | focussing section |
| 3 | focussed-state detection module, mirror module |
| 30 | focussed-state detection arrangement, autofocus sensor |
| 35 | mirror, main mirror |
| 36 | mirror, auxiliary mirror |
| 4 | control module |
| 40 | control circuit, microprocessor |
| 45 | shutter |
| 5 | adapter plate |
| 6 | image taking module, digital back |
| 60 | image taking element |
| 7 | focussed-state detection module, view finder module |
| 70 | focussed-state detection arrangement, focussing |
| | screen, groundglass |
| 83 | image plane of focussed-state detection arrangement, |
| | image plane of autofocus sensor |
| 86 | image plane of image taking element, image plane of |
| | CCD OR CMOS chip |
| 87 | image plane of focussed-state detection arrangement, |
| | image plane of focussing screen |
| 9, 9a, 9a′, 9b | light paths |
| 99 | object |
| 100, 110, | steps |
| 120, 130 | |
| A | first focussing state, before-image-taking focussing |
| | state |
| B | second focussing state, during-image-taking focussing |
| | state |
| L0 | length |
| L1 | length |
| L2 | length |
| δ | optical length, path length difference, δ = L2 − L1 |
| ε | focus shift for deliberate defocussing |
| Δε | travel of focus for deliberate defocussing |
| μP | microprocessor |

1. An image-taking apparatus (1) comprising
an image-forming optical system (20);
a focussing section (29);
a focussed-state detection arrangement (30;70) with an image plane (83;87);
an image-taking element (60) for taking an image in an image plane (86) of the image-taking element (60); and
a control module (4); wherein said control module (4) is adapted to adjusting said focussing section (29), so as to shift from a first focussing state (A) to a second focussing state (B), wherein said first focussing state (A) is an in-focus state with respect to said image plane (83;87) of said focussed-state detection arrangement (30;70), and wherein said second focussing state (B) is different from said first focussing state (A).

2. The apparatus according to claim 1, wherein said second focussing state (B) is closer to the desired infocus state with respect to said image plane (86) of said image-taking element (60) than said first focusing state (A).

3. The apparatus according to claim 1, wherein said second focussing state (B) is the desired in-focus state with respect to said image plane (86) of said image-taking element (60).

4. The apparatus according to claim 1, wherein said image-taking element (60) comprises at least one of
an imaging photochemical converter; and
an imaging photoelectric converter (60).

5. The apparatus according to claim 1, wherein said second focussing state (B) is a focussing state chosen such that said image taken in said image plane (86) of said image-taking element (60) is deliberately slightly out-of-focus.

6. The apparatus according to claim 5, wherein said second focussing state (B) is a fixed focussing state different from the desired in-focus state with respect to said image plane (86) of said image-taking element (60).

7. The apparatus according to claim 5, wherein said second focussing state (B) is a transient focussing state close to or comprising the desired in-focus state with respect to said image plane (86) of said image-taking element (60).

8. The apparatus according to claim 7, wherein said image-taking element (60) comprises a periodic array of photosensitive members.

9. The apparatus according to claim 1, wherein both a light path (9,9b) forming an image in said image plane (86) of said image-taking element (60) and a light path (9,9a;9,9a′) forming an image in said image plane (83;87) of said focussed-state detection arrangement (30;70) pass through said image-forming optical system (20).

10. The apparatus according to claim 1, wherein a light path (9,9b) forming an image in said image plane (86) of said image-taking element (60) is at least partially identical with a light path (9, 9a;9, 9a′) forming an image in said image plane (83;87) of said focussed-state detection arrangement (30;70).

11. The apparatus according to claim 10, wherein said two light paths have nearly the same optical path lengths, differing by an optical length δ≠0.

12. The apparatus according to claim 1, wherein said focussing section (29) is at least partially comprised in said image-forming optical system (20).

13. The apparatus according to claim 1, from which said image-forming optical system (20) is detachable.

14. The apparatus according to claim 1, comprising a focussed-state detection module (3;7), which is detachable and comprises said focussed-state detection arrangement (30;70).

15. The apparatus according to claim 1, comprising an image-taking module (6) which is detachable and comprises said image-taking element (60).

16. The apparatus according to claim 1, wherein said focussed-state detection arrangement (3;7) comprises at least one of
an autofocus sensor (30);
a focussing screen (70); and
an imaging photoelectric converter.

17. The apparatus according to claim 1, which is a camera system (1).

18. A control module (4) for an image-taking apparatus (1) for adjusting a focussing section (29) of said image-taking apparatus (1) so as to shift from a first focussing state (A) to a second focussing state (B), wherein
said first focussing state (A) is a desired in-focus state with respect to an image plane (83;87) of a focussed-state detection arrangement (30;70) of said image-taking apparatus (1), and wherein
said second focussing state (B) is different from said first focussing state (A).

19. The control module according to claim 18, wherein said second focussing state (B) is closer to the desired in-focus state with respect to said image plane (86) of said image-taking element (60).

20. The control module according to claim 18, wherein said second focussing state (B) is
a fixed focussing state different from the desired in-focus state with respect to said image plane (86) of said image-taking element (60), or
a transient focussing state close to or comprising the desired in-focus state with respect to said image plane (86) of said image-taking element (60).

21. A method of manufacturing a photograph comprising, the sequential steps of:
a) focussing, so as to reach a first focussing state (A), which is a desired in-focus state with respect to an image plane (83;87) of a focussed-state detection arrangement (30;70);
b) shifting from said first focussing state (A) to a second focussing state (E), which is different from said first focussing state (A); and
c) taking an image by means of said image-taking element (60).

22. The method according to claim 21 wherein said second focussing state (E) is closer to the desired in-focus state with respect to an image plane (86) of an image-taking element (60) than without the shifting, in particular identical with the desired in-focus state with respect to an image plane (86) of an image-taking element (60).

23. The method according to claim 21, wherein said second focussing state (E) is a focussing state chosen such that said image taken by means of said image-taking element (60) is deliberately slightly out-of-focus.

24. The method according to claim 23, wherein said second focussing state (B) is a fixed focussing state slightly different from the desired in-focus state with respect to an image plane (86) of said image-taking element (60).

25. The method according to claim 23, comprising the step of d) shifting the focus while taking an image by means of said image-taking element (60).

26. The method according to claim 25, wherein step b) is a shifting of the focus by a predetermined amount (6).

27. The method according to claim 26, wherein step b) is performed automatically.

28. The method according to claim 27, wherein step c) is performed while in said second focussing state (B).

29. The method according to claim 28, comprising after step c) the step of d) shifting from said second focussing state (B) to said first focussing state (A).
